(19) United States
(12) Patent Application Publication
(10) Pub. No.: US 2014/0006716 A1
(43) Pub. Date: Jan. 2, 2014

(54) DATA CONTROL USING LAST ACCESSOR INFORMATION

(71) Applicants: Simon C. Steeley, JR., Hudson, NH (US); William C. Hasenplaugh, Boston, MA (US)

(72) Inventors: Simon C. Steeley, JR., Hudson, NH (US); William C. Hasenplaugh, Boston, MA (US)

(21) Appl. No.: 13/993,779

(22) PCT Filed: Dec. 29, 2011
(86) PCT No.: PCT/US11/67897

§ 371 Date: Jun. 13, 2013

(51) Int. Cl. G06F 12/08

(52) U.S. Cl. CPC G06F 12/084
USPC 711/130

(57) ABSTRACT

In some implementations, a shared cache structure may be provided for sharing data among a plurality of processor cores. A data structure may be associated with the shared cache structure, and may include a plurality of entries, with each entry corresponding to one of the cache lines in the shared cache. Each entry in the data structure may further include a field to identify a processor core that most recently requested the data of the cache line corresponding to the entry. When a request for a particular cache line is received, a request for the data may be sent to a particular processor core identified in the data structure as the last accessor of the data.

### TECHNICAL FIELD

This disclosure relates to the technical field of microprocessors.

### BACKGROUND ART

Multiprocessor systems may employ two or more computer processors or processor cores that can communicate with each other and with shared memory, such as over a bus or other interconnect. In some instances, each processor core may utilize its own local cache memory that is separate from a main system memory. Further, each processor core may sometimes share a cache with one or more other processor cores. Having one or more cache memories available for use by the processor cores can enable faster access to data than having to access the data from the main system memory.

When multiple processors cores share memory, various conflicts, race conditions, or deadlocks can occur. For example, if one of the processor cores changes a portion of the data without proper coherency control, the other processor cores would then be left using invalid data. Accordingly, coherency protocols are typically utilized to maintain coherence between all the caches in a system having distributed shared memory and multiple caches. Coherency protocols can ensure that whenever a processor core reads a memory location, the processor core receives the correct or most up-to-date version of the data. Additionally, coherency protocols help the system state to remain deterministic, such as by determining an order in which accesses to data should occur when multiple processor cores request the same data at essentially the same time. For example, a coherency protocol may ensure that the data received by each processor core in response to a request preserves a determined order.

### BRIEF DESCRIPTION OF THE DRAWINGS

The detailed description is set forth with reference to the accompanying figures. In the figures, the left-most digit(s) of a reference number identifies the figure in which the reference number first appears. The use of the same reference numbers in different figures indicates similar or identical items or features.

FIG. 1 illustrates an example architecture of one or more processors in a system that uses last accessor information for cache control according to some implementations.

FIG. 2 illustrates an example directory structure including last accessor information according to some implementations.

FIG. 3 illustrates details of select components of an example of the architecture of FIG. 1 according to some implementations.

FIG. 4 illustrates an example of using last accessor information for cache control according to some implementations.

FIG. 5 illustrates an example missed address file entry according to some implementations.

FIG. 6 is a block diagram illustrating an example process using last accessor information for cache control according to some implementations.

FIG. 7 illustrates an example architecture of a system to use last accessor information for cache control according to some implementations.

### DETAILED DESCRIPTION

### Maintaining Cache Coherency

This disclosure includes techniques and arrangements for a cache coherency protocol and arrangement that is able to relieve congestion and eliminate deadlock scenarios. Some implementations utilize last accessor information to avoid stalling of probes for data from processor cores in a multiprocessor system that employs a shared cache. For instance, when a given processor core generates a request for desired data in response to a cache miss at a local cache, a shared cache structure may be accessed to provide a data fill of the desired data. Thus, the processor core may send a read request to a directory that tracks use or ownership of data stored in cache lines of the shared cache. For example, the directory may include information of one or more processor cores that currently have particular data in their own local caches.

The directory may further include last accessor information that indicates a particular processor core that last requested access to the particular data. For example, in a situation in which probes for data are directed to various processor cores to obtain data, the probes may sometimes be stalled to avoid race conditions. The last accessor information identifies a particular processor core to which a probe is sent to request access to the data. The requesting processor core is then identified as the last accessor. A subsequent probe for the data from another processor core may be sent to only the last accessor, rather than to one or more other processor cores that may also be using the data. If a processor core that receives a probe is unable to provide a cache line fill right away, such as in the case in which the processor core has not yet received the data itself, rather than stalling the probe and risking backing up the probe queue, the processor core may store the probe information in a local missed address file (MAF). The processor core may then respond to the probe subsequently after the data is received based on the entry in the MAF. Because, at most, one probe is sent to only the last accessor for each data access request, storing probe information in the MAF does not pose a threat of overflowing the MAF.

Some implementations may apply in multiprocessor systems that employ two or more computer processors or processor cores that can communicate with each other and share a data stored in a cache. Further, some implementations are described in the environment of multiple processor cores in a processor. However, the implementations herein are not limited to the particular examples provided, and may be extended to other types of processor architectures and multiple processor systems, as will be apparent to those of skill in the art in light of the disclosure herein.

### Example Architecture

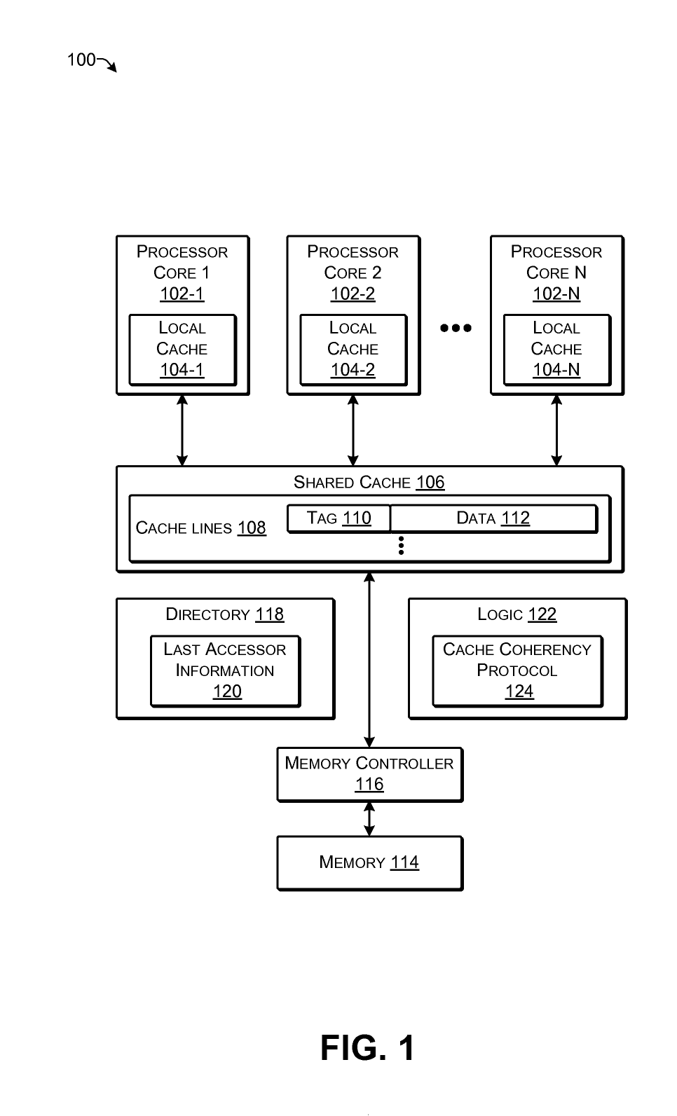

FIG. 1 illustrates an example architecture of a system 100 according to some implementations. The system 100 may include one or more processors that provide a multiprocessor environment that includes a plurality of processor cores 102-1, 102-2, . . . , 102-N, (where N is a positive integer>1). Each of the processor cores 102-1, 102-2, . . . , 102-N may include at least one respective local cache 104-1, 104-2, . . . , 104-N. For purposes of brevity, each of the respective local caches 104 are depicted in FIG. 1 as unitary memory devices, although local caches 104 may include a plurality of memory devices or different cache levels, as discussed in additional implementations below. In some implementations, the processor cores 102 may each be separate unitary processors, while in other implementations, the processor cores 102 may be multiple cores of a single processor or multiple cores of multiple processors formed on a single die, multiple dies, or any combination thereof.

The system 100 also includes a shared cache 106 operatively connected to the plurality of processor cores 102. The system 100 may employ the individual caches 104 and the shared cache 106 to store blocks of data, referred to herein as memory blocks or data fills. A memory block or data fill can occupy part of a memory line, an entire memory line or span across multiple lines. For purposes of simplicity of explanation, however, it will be assumed herein that a “memory block” occupies a single “memory line” in memory or a “cache line” in a cache. Accordingly, a given memory block can be stored in a cache line of one or more of the caches 104 and 106. Each of the caches 104, 106 contains a plurality of cache lines 108 (for clarity, not shown in each of the caches 104 in FIG. 1). Each cache line 108 may have an associated address or “tag” 110 that identifies corresponding data stored in the cache line 108. In some cases, the cache lines 108 may also include additional information, such as information identifying a state of the data for the respective lines and other management information.

The system 100 further includes a memory 114 in communication with the shared cache and/or the processor cores 102. The memory 114 can be implemented as a globally accessible aggregate memory controlled by a memory controller 116. For example, the memory 114 can include one or more memory storage devices (e.g., dynamic random access memory (DRAM), RAM, or other suitable memory devices that are known or may become known). Similar to the caches 104, 106, the memory 114 stores data as a series of addressed memory blocks or memory lines. The processor cores 102 can communicate with each other, caches 104, 106, and memory 114 through requests and corresponding responses that are communicated via buses, system interconnects, a switch fabric, or the like. The caches 104, 106, memory 114, as well as the other caches, memories or memory devices described herein are examples of computer-readable media, and may be non-transitory computer-readable media.

A directory 118 that includes last accessor information 120 may be provided to assist in implementation of a cache coherency protocol to maintain cache coherency among the local caches 104 and the shared cache 106. In some implementations, the directory 118 is a logical directory data structure that is maintained in a distributed fashion among the processor cores 102. In other implementations, the directory 118 may be a data structure maintained in a single location, such as in a location associated with the shared cache 106. As mentioned above, the directory 118 may include last accessor information 120 that indicates a processor core that most recently requested access to a particular cache line. The last accessor information 120 may be used to limit subsequent requests or probes for the particular cache line, which can avoid stalls and eliminate deadlock scenarios, as discussed additionally below.

Further, logic 122 may be provided in the system 100 to manage the directory 118, send and receive probes, control the caches and perform other functions to implement at least a portion of a cache coherency protocol 124 described herein. In some instances, the logic 122 may be implemented in one or more controllers (not shown in FIG. 1). For example, as described below, the logic 122 may be implemented by multiple controllers in some examples. However, in other examples, the logic 122 may be implemented by a single controller, one or more dedicated circuits, combinations thereof, and so forth. Accordingly, implementations herein are not limited to the particular examples illustrated in the figures.

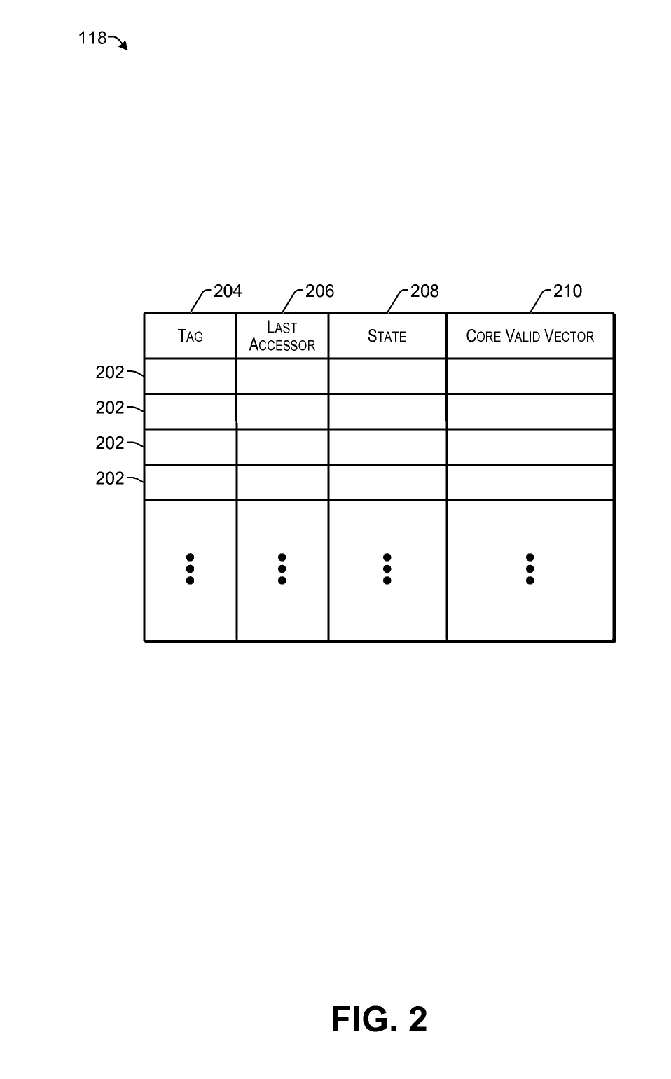

FIG. 2 illustrates a nonlimiting example configuration of the directory 118 according to some implementations. The directory 118 may include a plurality entries 202, with each entry corresponding to a cache line in the shared cache 106 or the local caches 104. Each entry 202 may include an address or tag field 204 that identifies a memory location or memory address of the data corresponding to the particular cache line. The directory 118 also include a last accessor field 206 that may include last accessor information that identifies a processor core that last requested the cache line corresponding to the entry. For example, the last accessor information for a particular entry 202 is changed each time a different processor core requests access to a cache line corresponding to the particular entry 202.

The directory 118 may also include a state field 208 that identifies a state of the data with respect to the last accessor. For example, if the last access request to a particular cache line was a write request, then the last accessor will have a more up-to-date version of the data for that line. Consequently, to process a subsequent request to the same line, the particular processor core identified as the last accessor is probed to obtain a fill, rather than using a version of the data stored in the shared cache 106. Further, the directory 118 may include a core valid vector field 210 that is a presence vector indicating which of the processor cores 102 have a copy of a given cache line. As one nonlimiting example, suppose that there are eight processor cores, then the core valid vector may have eight bits, with a “0” bit indicating a particular core does not have a copy of the data and a “1” bit indicating the a particular core does have a copy of the data (or vice versa). Thus, the cache coherency protocol 124 may refer to the core valid vector to identify all processor cores that currently have a copy of data corresponding to any particular cache line.

The cache coherency protocol 124 may utilize a plurality of states to identify the state of the data stored in a respective cache line. Thus, a cache line can take on several different states relative to the processor cores 102, such as “invalid,” “shared,” “exclusive,” or “modified.” When a cache line is “invalid,” then the cache line is not present in the processor core's local cache. When a cache line is “shared,” then the cache line is valid and unmodified by the caching processor core. Accordingly, one or more other processor cores may also have valid copies of the cache line in their own local caches. When a cache line is “exclusive,” the cache line is valid and unmodified by the caching processor core, but the caching processor core has the only valid cached copy of the cache line. When a cache line is “modified,” the cache line is valid and has been modified by the caching processor core. Thus, the caching processor core has the only valid cached copy of the cache line.

The cache coherency protocol 124 establishes rules for transitioning between states, such as if data is read from or written to the shared cache 106 or one of the local caches 104. The directory 118 entry 202 for a particular piece of data may provide the core valid vector 210 that indicates which processor cores have a copy of a particular cache line, and the state of the cache line. For example, suppose that a first processor core 102-1 requires a copy of a given memory block. The first processor core 102-1 first requests the memory block from its local cache 104-1, such as by identifying the address or tag associated with the memory block and the cache line containing the memory block. If the requested data is found at the local cache 104-1, the memory access is resolved without communication with the shared cache 106 or the other processor cores 102. However, when the requested memory block is not found in the local cache 104-1, this is referred to as a cache miss. The first processor core 102-1 can then generate a request for the data from the shared cache 106 and/or the other local caches 104 of the other processor cores 102. The request can identify an address associated with the requested memory block and the type of request or command being issued by the requester.

If the requested data is available (e.g., one of the other caches 104, 106 has a shared, exclusive, or modified copy of the memory block), then the data may be provided to the first processor core 102-1 and stored in the local cache 104-1. The directory 118 may be updated to show that the data is now stored locally by the first local cache 104-1. The state 208 of the cache line may also be updated in the directory 118 depending on the type of request and the previous state of the cache line. For example, a read request on a shared cache line will not result in a change in the state of the cache line, as a copy of the latest version of the cache line is simply shared with the first processor core 102-1. On the other hand, when the cache line is exclusive to another processor core 102, a read request will require the cache line to change to a shared state with respect to the first processor core 102-1 and the providing processor core. Further, a write request will change the state of the cache line to modified with respect to the first processor core 102-1, and invalidate any shared copies of the cache line at other processor cores. Accordingly, in some implementations, valid request types may include “read,” “read-exclusive,” “exclusive,” and “exclusive-without-data.” Furthermore, dirty sharing may be permitted in the system 100, which enables direct sharing of data between processor cores 102 without updating the share cache 106.

Additionally, in some alternative examples, the system 100 can further comprise one or more additional sets of processor cores (not shown) that share memory 114, and that each include additional local and shared caches. In such a case, the system 100 may include a multi-level cache coherency protocol to manage the sharing of memory blocks among and within the various sets of processors to guarantee coherency of data across the multiple sets of processors cores.

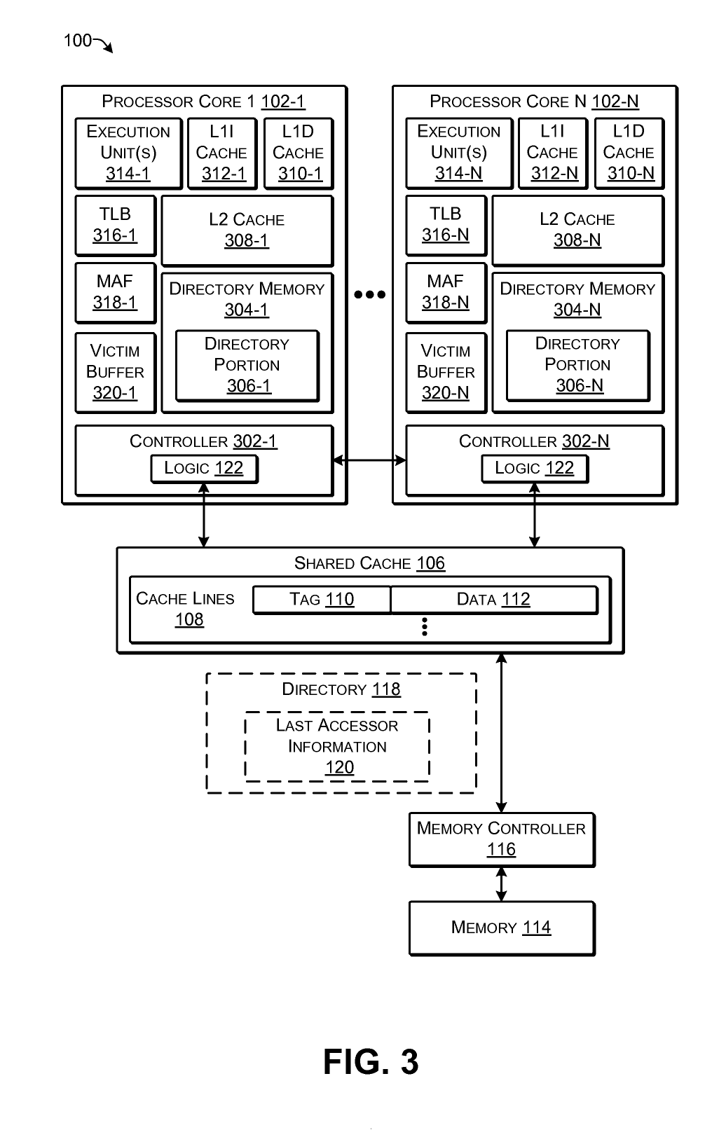

FIG. 3 illustrates additional nonlimiting details of the example system 100 of FIG. 1, including details of select components according to some implementations. In the example system 100 of FIG. 3, each processor core 102-1, . . . , 102-N includes a respective controller 302-1, . . . , 302-N that may control communications between the processor cores 102 with respect to the directory 118 and/or each other, and perform various other functions, as described below. Further, in this example, the directory 118 may be a logical directory, as indicated by dashed lines, and portions of directory 118 may be distributed and maintained by the respective controllers 302 of one or more of the processor cores 102. Thus, the directory 118 in this example may be a distributed data structure maintained at multiple processor cores 102 of the plurality processor cores 102 by multiple controllers 302 corresponding to respective ones of the multiple processor cores 102. For example, in some implementations, each processor core 104 may include a directory memory 304, which may be a memory bank or other suitable memory device that maintains a directory portion 306. Each directory portion 306 at the individual processor cores 102 may make up a portion of the overall logical directory 118.

Given the address of a particular cache line that is the subject of an operation, the corresponding memory location of the directory 118 to service that address can be located from among the directory portions 306 at the multiple processor cores 102. Each controller 302 associated with each directory memory 304 is able to process request packets that arrive from other controllers 302 at other processor cores 102, and may generate further packets to be sent out, as required, to perform operations with respect to the logical directory 118. Thus, each controller 302 may contain at least a portion of logic 122 described above. In one nonlimiting example, each controller 302 may operate through execution of microcode instructions, dedicated circuits, or other control logic to implement the logic 122 and coherency protocol 124.

As an illustrative example, suppose that processor core 102-N needs a particular cache line, and the controller 302-N issues a read request. The read request packet travels to the appropriate directory portion 306 of the directory 118 based on the address of the cache line that is the subject of the request. For example, suppose that the entry for the particular cache line is located in the directory portion 306-1 at processor core 102-1. The read request packet is received by the controller 302-1 and the controller 302-1 looks up and examines the directory entry. If the directory entry indicates that a copy of the requested cache line is in a local cache at another processor core e.g., processor core 102-2 (not shown in FIG. 3), then the controller 302-1 sends a read probe to the controller 302-2 at the other processor core 102-2. When the read probe arrives at that other processor core 102-2, the controller 302-2 accesses the particular cache location and generates a fill to return to the original requesting processor core 302-N.

In the illustrated example of FIG. 3, each processor core 102 may further include a multi-level local cache including a level two (L2) cache 308, a level one data (L1D) cache 310, and a level one instruction (L1I) cache 312. In some implementations, the controller 302 may serve as a cache controller, while in other implementations a separate cache controller (not shown) may be included at each processor core 102 for controlling operations with respect to the L2 cache 308 and L1 caches 310, 312. Accordingly, in this example, the shared cache 106 maybe a level three (L3) cache also controlled by the controllers 302 or by a separate cache controller (not shown).

In addition, in an alternative configuration (not shown in FIG. 3), the shared cache 106 may be a logical shared cache that is physically distributed across the processor cores 102 in a manner similar to that described above for the directory 118. Thus, a portion of the shared cache 106 may be physically maintained in a respective memory unit associated with each processor core 102. In some examples, a portion of an L3 cache may be provided in association with each processor core 102 to make up the logical shared cache 106. Alternatively, the L2 cache 308 at each processor core 102 may make up a portion of the logical shared cache 106. Other variations will also be apparent to those of skill in the art in view of the disclosure herein.

In the illustrated example, each processor core 102 may further include one or more execution units 314, a translation lookaside buffer (TLB) 316, a missed address file (MAF) 318, and a victim buffer 320. The execution unit(s) 314 may include one or more execution pipelines, arithmetic logic units, load/store units, and the like. The TLB 316 may be employed to improve speed of mapping virtual memory addresses to physical memory addresses. In some implementations, multiple TLBs 316 may be employed.

The MAF 318 may be used to maintain cache line requests that have not yet been filled at a particular processor core 102. For example, the MAF 318 may be a data structure that is used to manage and track requests for each cache line made by the respective processor core 102 that maintains the MAF. When there is a cache miss at the processor core 102, an entry for the cache line is added to the MAF 318 and a read request is sent to the directory 118. A given entry in the MAF 318 may include fields that identify the address of the cache line being requested, the type of request, and information received in response to the request. The MAF 318 may include its own separate controller (not shown), or may be controlled by controller 302.

The victim buffer 320 may be a cache or other small memory device used to temporarily hold data evicted from the L2 cache 308 or the L1 data cache 310 upon replacement. For example, in order to make room for a new entry on a cache miss, the cache 308, 310 has to evict one of the existing entries. The evicted entry may be temporarily stored in the victim buffer 320 until confirmation of a writeback is received at the particular processor core. The provision of the victim buffer 320 can prevent a late-request-race scenario in which the directory 118 indicates that a particular cache line is maintained at a particular local cache and another controller 302 sends a probe for the cache line, while simultaneously the cache controller 302 at the particular processor core has evicted the cache line. Thus, without the victim buffer 320, because the directory 118 has not been updated to reflect that the cache line has been evicted, the probe for the data is sent to the processor core that evicted the data, but cannot be filled because the data is no longer there. With the implementation of a victim buffer 320, however, a probe that arrives at a particular processor core will either find the data in the local caches 308, 310, or in the victim buffer 320 and will be serviced through one or the other.

### Race Handling

The above-described late-request-race scenario is one of two possible race events that may occur when a request is forwarded from the directory 118 to a particular processor core. Another possible race event that may occur is an early-request-race scenario, discussed below. The late-request race occurs when the request from the directory 118 arrives at the owner of a cache line after the owner has already written back the cache line to the shared cache 106. On the other hand, the early-request race occurs when a request arrives at the owner of a cache line before the owner has received its own requested copy of the data. The coherency protocol 124 herein addresses both race scenarios to ensure that a forwarded request is serviced without any retrying or blocking at the directory 118.

As mentioned above, a local victim buffer 320 may be implemented with each processor core 102 to prevent the late-request race from occurring. Thus, the late-request race is prevented by maintaining a valid copy of the data at the owner processor core 102 until the directory 118 acknowledges the writeback, which allows any forwarded requests for the data to be satisfied in the interim. According to these implementations, when one of the processor cores 102 victimizes a cache line, the cache line is moved to the local victim buffer 320, and a victim buffer controller (e.g., controller 302, or a separate controller in some implementations) awaits receipt of a victim-release signal from the directory 118 before discarding the data from the victim buffer 320. For example, whichever controller 302 manages the directory portion 306 that maintains the evicted cache line will send back a victim release signal when the directory 118 has been updated to show that the processor core is no longer the owner of the evicted cache line. Further, the victim-release signal may be effectively delayed until all pending forwarded requests from the directory 118 to a given processor for the particular cache line are satisfied. Accordingly, in some implementations, the victim buffer entry is maintained until the victim-release signal (e.g., an order marker message) arrives back from the directory 118 indicating that the evicted data has been migrated and the directory entry no longer points to a copy of the data in the cache at the particular processor core. The above approach alleviates the need for complex address matching (conventionally used in snoopy designs) between incoming and outgoing queues.

The early request race occurs if a request arrives at the owner processor core before the owner has received its own copy of the data. According to some implementations herein, the early request race may involve delaying the forwarded request until the data arrives at the owner. For example, the controller 302 may compare an address at the head of the inbound probe queue against addresses in the processor core's MAF 318, which tracks pending misses. When a match is found, this means that the processor core has not yet received a requested cache line (i.e., the address of the cache line is still listed in the local MAF 318), and therefore the request from the other processor core is stalled until it can be responded to. In some implementations, stalling the requests at target processors provides a simple resolution mechanism, and is relatively efficient since such stalls are rare and the amount of buffering at target processor cores is usually sufficient to avoid impacting overall system progress. Nevertheless, naive use of this technique can potentially lead to deadlock when probe requests are stalled at more than one processor core. Consequently, according to some implementations herein, such deadlock scenarios may be eliminated by the use of last accessor information 120 and by adding probe information to a local MAF 318, as discussed additionally below.

### Using Last Accessor Information

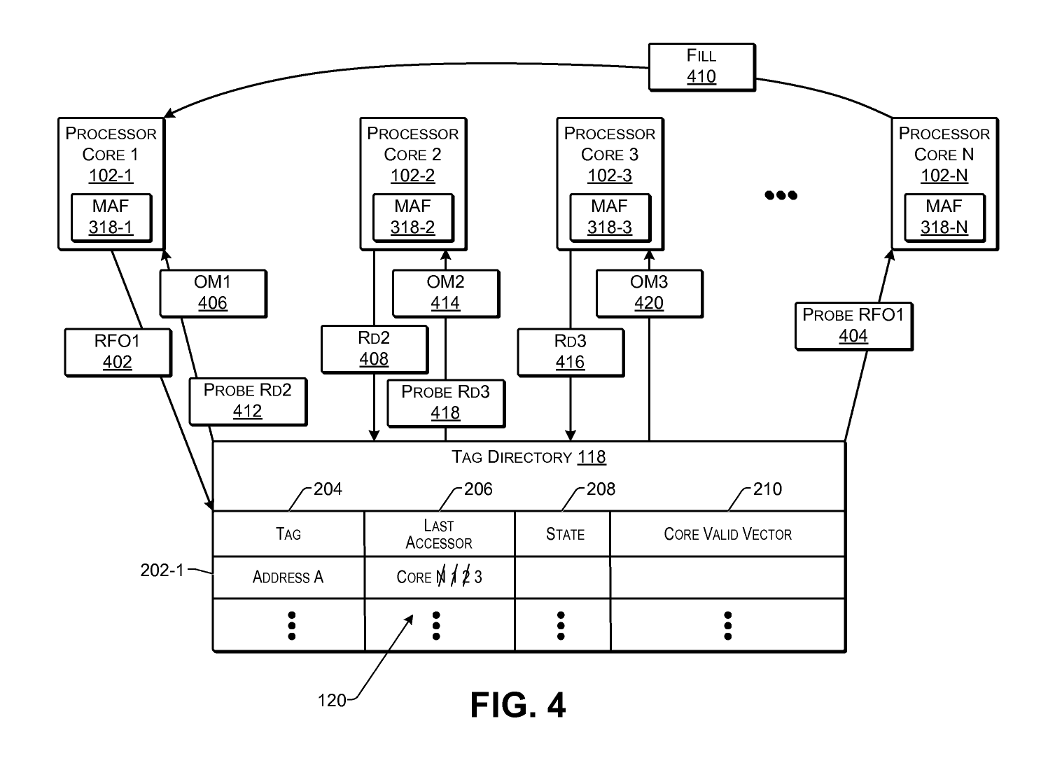

FIG. 4 illustrates an example of using last accessor information in the directory 118 according to some implementations. For example, the system 100 may utilize an ordering of messages in a virtual lane for messages from the directory 118 to processor cores 102 without depending on negative-acknowledgements (NAKs) and retries, or blocking at the directory 118. Conventionally, NAKs are typically used in scalable coherence protocols to resolve resource dependencies that may result in deadlock (e.g., when outgoing network lanes back up), and to resolve races where a request fails to find the data at the processor to which the request is forwarded. Similarly, blocking at a directory may conventionally be used to sometimes resolve such races. Eliminating NAKs/retries and blocking at the directory according to implementations herein provides several desirable characteristics. For instance, by guaranteeing that an owner processor core can always service a forwarded request, all directory state changes can occur immediately when the directory is first visited. Hence, all transactions may be completed, from a processor core's point of view, with a single access to the directory 118. This leads to fewer messages and less resource occupancy for read and write transactions (involving a remote owner). Additionally, transactions may immediately update the directory 118, regardless of other ongoing transactions to the same cache line. Hence, implementations herein avoid blockages and extra occupancy at the directory 118, and instead resolve dependencies at the system periphery. The cache coherency protocol 124 herein is scalable and able to support hundreds of processor cores 102 in the same cache-coherent memory domain.

Without utilizing the last accessor information and techniques disclosed herein, requests forwarded from the directory 118 may either find the requested data in a processor core local cache 104 or the victim buffer 320, or may be stalled in the probe queue at the processor core until the requested data arrives. Unfortunately, stalling probes can back up work, cause congestion issues, and may lead to deadlock when the top of probe queues at multiple processor cores are stalled waiting for data to arrive and the data is coming from probes that are also stalled in those probe queues.

As mentioned above, the directory 118 may maintain last accessor information 120, such as in the last accessor field 206. Each time an entry 202 in the directory 118 is accessed, the last-accessor field 206 is updated to reflect the identity of the processor core 102 that most-recently requested the cache line corresponding to that directory entry 202. Furthermore, a probe that results from processing a request is sent only, at most, to the last accessor. This means that the dirty-shared state is also migrated to the last accessor. Accordingly, utilizing the last accessor information in this way provides that, at most, one probe will arrive per requester in a chain of requests that occur in parallel to the same cache line.

FIG. 4 illustrates a nonlimiting example of using last accessor information according to some implementations herein. Suppose that the processor core 102-N currently has ownership of a cache line A having an address A and an entry 202-1 in the directory 118. Further, suppose that the processor core 102-1 issues a request for ownership (RFO1) 402 of the cache line A. At the time the RFO1 402 is issued, the last accessor information 120 in the directory 118 might indicate that processor core N is the last processor core to request access to cache line A. A controller (e.g., one of controllers 302 (not shown in FIG. 4)) associated with the directory 118 checks the last accessor field 206 and detects that processor core N last requested access to the cache line A. Accordingly, the controller sends a probe RFO1 404 to processor core 102-N to request that the cache line A be sent to the processor core 102-1. Additionally, the controller changes the last accessor information 120 in the last accessor field 206 to show that processor core 102-1 (core 1) is now the last accessor, and sends an order marker OM1 406 back to processor core 102-1 in response to the RFO1 402. The controller may also update the core valid vector field 210 to reflect that core 1 has the cache line A. The state field 208 may not need to be updated, as the state field 208 generally indicates whether the copy of the cache line A in the shared cache can be used or whether one of the processor cores has a more up-to-date version. Thus, the state field 208 may not be changed until a writeback to the shared cache 106 takes place.

Furthermore, suppose that processor core 102-2 also wants access to cache line A and sends a read request (Rd2) 408 to obtain a copy of the cache line A before a fill 410 for cache line A is delivered from the processor core 102-N to processor core 102-1. The controller checks the last accessor information and identifies processor core 102-1 as the last accessor. Accordingly, the controller sends a probe Rd2 412 to processor core 102-1, updates the last accessor field 206 to reflect that the last accessor is now processor core 102-2 (core 2), updates the core valid vector field 210 to show that processor core 102-2 has a copy of cache line A, and sends an order marker OM2 414 back to processor core 102-2.

As mentioned above, the order marker OM1 406 and the probe Rd2 412 might arrive at processor core 102-1 before the fill 410 for the cache line A. Accordingly, rather than stalling the probe queue at processor core 102-1, the order marker OM1 406 and the probe Rd2 412 are entered into the MAF 318-1 at the processor core 1 102-1. Thus, there is no stalling of the probe queue at processor core 102-1. For example, processor core 102-1 already created an entry in the MAF 318-1 when a cache miss occurred for cache line A, which led to the initial RFO1 402. Accordingly, the MAF controller may add probe information to the existing entry for the probe received from processor core 102-2. Additionally, because processor core 102-1 is no longer the last accessor, any future probe is sent to the new last accessor, so that the MAF 318-1 is not filled by a large number of probes.

Next, suppose that processor core 102-3 also sends a read request Rd3 416 for cache line A, which could also occur before the fill 410 takes place. The controller checks the last accessor information and identifies processor core 102-2 as the last accessor. Accordingly, the controller sends a probe Rd3 418 to processor core 102-2, updates the last accessor field 206 to reflect that the last accessor is now processor core 102-3 (core 3), updates the core valid vector field 210 to include processor core 102-3, and sends an order marker OM3 420 to processor core 102-3. The order marker OM2 414 and the probe Rd3 418 might arrive at processor core 102-2 before any fill from processor core 102-1 arrives at processor core 102-2, or even before the fill 410 from processor core 102-N arrives at processor core 102-1. Accordingly, rather than stalling the probe queue at processor core 102-2, the order marker OM2 414 and the probe Rd3 418 are entered into an entry at the MAF 318-2 at the processor core 102-2. Thus, there is no stalling of the probe queue at processor core 102-2, and because processor core 102-2 is no longer the last accessor, any future probes for cache line A will be sent to processor core 102-3, so that the entry in the MAF 318-2 will not be filled by additional probes.

The foregoing example sets forth a coherency protocol in which probes that are sent to processor cores 102 are either serviced by the core caches 104, 308, 310, or serviced by the victim buffer 320 (as discussed above with respect to the late-request race), or saved away in an MAF entry (in the case of an early-request race) in the MAF 318. This eliminates any deadlock scenarios and contributes to large scalability of system architectures to enable efficient sharing of data among of hundreds of processor cores.

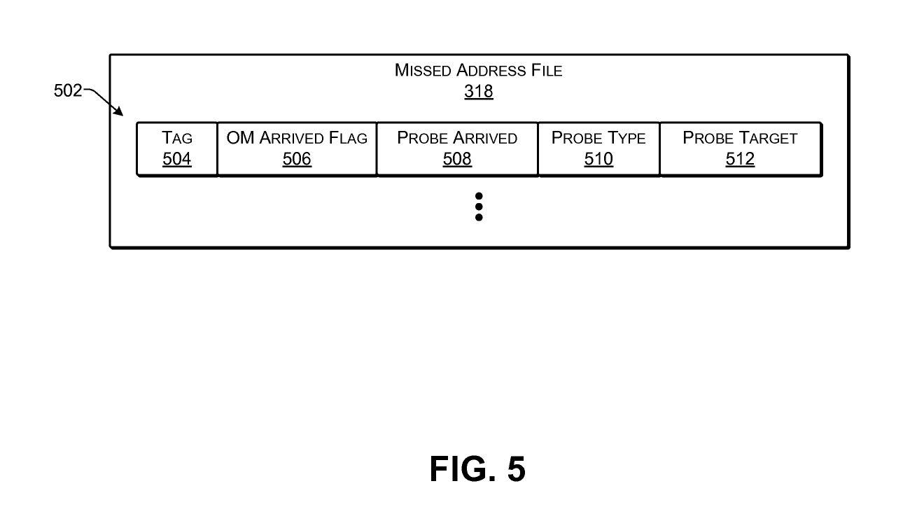

FIG. 5 illustrates an example entry 502 in the missed address file (MAF) 318 according to some implementations. Since, at most, only one probe can arrive in the early-request race scenario, implementations herein may add one or more fields to entries 502 in the MAF 318, so that MAF entries 502 are able to hold probe information. In the illustrated example, the MAF entry 502 includes a tag field 504 that may contain the memory address of the corresponding cache line that is the subject of the entry. For example, when a cache miss takes place, the entry 502 may be created in the local MAF 318. MAF entry 502 may also include an OM-arrived flag 506 that indicates that an order marker for the cache line arrived before the probe request for the cache line. Thus, this indicates that the cache line was requested by the present processor core before the probe was sent with respect to the other processor core. The MAF entry 502 may also include a probe arrived field 508 that indicates when the probe arrived; a probe type field 510 that indicates a type of the probe request; and a probe target field that indicates the processor core that is making the request. When the data fill to the first processor core takes place, the data may then also be forwarded to the other processor core based on the probe information.

Through the techniques described herein, implementations can save probes in MAF entries 502 to address the early-request-race. Accordingly, probes that are sent to processor cores are either serviced by the processor core caches, serviced by the core's victim buffer, or saved in an MAF entry 502. Further, in a system with a hierarchical tag directory, it is possible to get a probe from each level of the tag-directory and the MAF entries must have room to save a probe per level of tag-directory as well as an invalidate message. By always probing the last accessor, the probes can be saved with finite storage and thus do not backup or stall the probe channel.

### Example Process

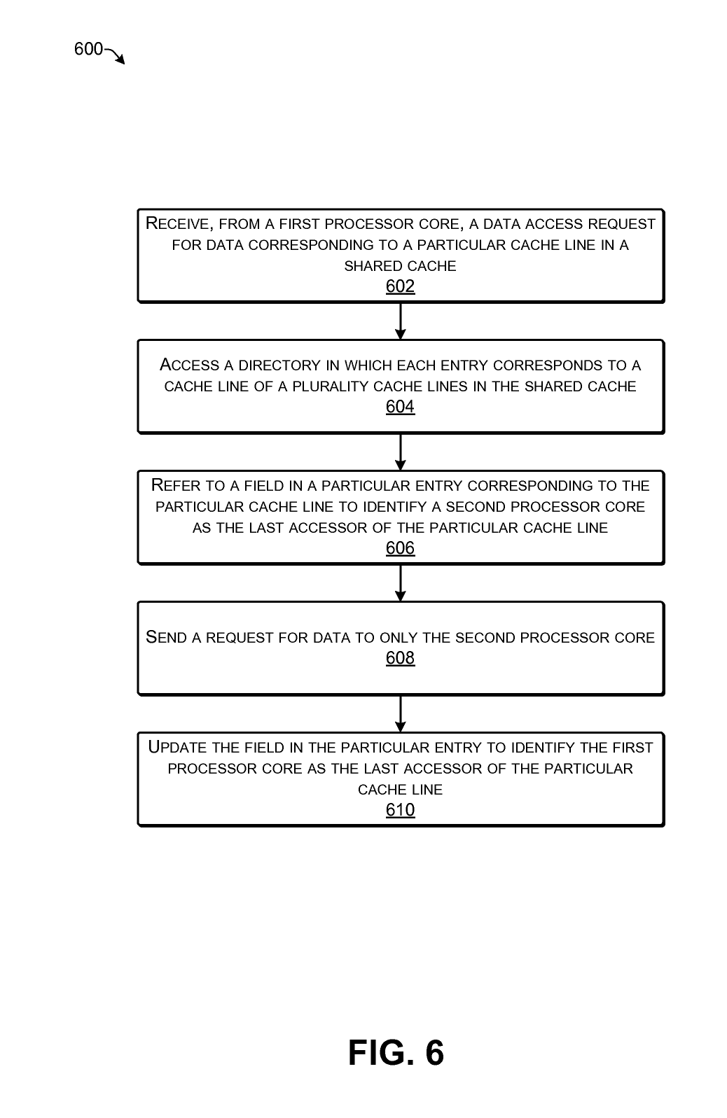

FIG. 6 illustrates an example process for implementing the techniques described above. The process is illustrated as a collection of operations in a logical flow graph, which represents a sequence of operations, some or all of which can be implemented in hardware, software or a combination thereof. In the context of software, the blocks represent computer-executable instructions stored on one or more computer-readable media that, when executed by one or more processors, perform the recited operations. Generally, computer-executable instructions include routines, programs, objects, components, data structures and the like that perform particular functions or implement particular abstract data types. The order in which the operations are described is not intended to be construed as a limitation. Any number of the described blocks can be combined in any order and/or in parallel to implement the process, and not all of the blocks need be executed. For discussion purposes, the process is described with reference to the architectures, apparatuses and environments described in the examples herein, although the process may be implemented in a wide variety of other architectures, apparatuses or environments.

FIG. 6 is a flow diagram illustrating an example process 600 for using last accessor information for cache coherency according to some implementations.

At block 602, logic receives, from a first processor core, a data access request for data corresponding to a particular cache line in a shared cache. For example, in response to a cache miss, the first processor core may issue a request for data to the directory 118, which is received by a controller than handles the portion of the directory 118 that includes the cache line corresponding to the cache miss.

At block 604, the logic accesses a directory having a plurality of entries in which each entry corresponds to a cache line of a plurality cache lines in the shared cache. For example, a controller may access the directory 118 to locate the entry corresponding to the requested cache line.

At block 606, the logic refers to a field in a particular entry corresponding to the particular cache line to identify a second processor core that last requested access to the particular cache line. For example, a controller identifies the processor core that most recently requested access to the particular cache line as the last accessor.

At block 608, the logic sends a request for the data to only the second processor core. For example, a controller sends a request for the data to the processor core identified in the directory 118 as being the last accessor of the particular cache line.

At block 610, the logic updates the field in the particular entry to identify the first processor core as the last accessor of the particular cache line. Thus, the first processor core becomes the new last accessor for the particular cache line, and any subsequently received probe will be forwarded only to the first processor core.

The example process described herein is only an example of a process provided for discussion purposes. Numerous other variations will be apparent to those of skill in the art in light of the disclosure herein. Further, while the disclosure herein sets forth several examples of suitable architectures and environments for executing the techniques and processes herein, implementations herein are not limited to the particular examples shown and discussed.

### Example System Architecture

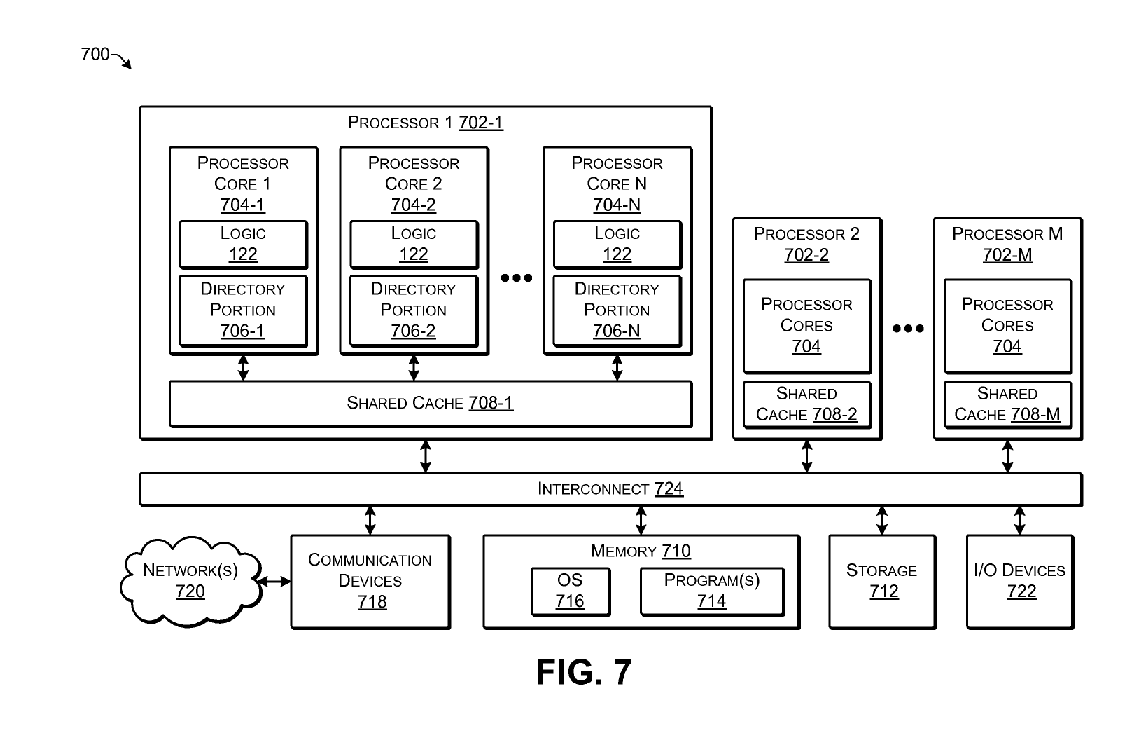

FIG. 7 illustrates nonlimiting select components of an example system 700 according to some implementations herein that may include one or more instances of the processor architecture 100 discussed above for implementing the cache control techniques described herein. The system 700 is merely one example of numerous possible systems and apparatuses that may implement data control using last accessor information, such as discussed above with respect to FIGS. 1-6. The system 700 may include one or more processors 702-1, 702-2, . . . , 702-M (where M is a positive integer≧1), each of which may include one or more processor cores 704-1, 704-2, . . . , 704-N (where N is a positive integer>1). In some implementations, as discussed above, the processors 702 may be single core processors that share a cache amongst them (not shown in FIG. 7). In other implementations, as illustrated in FIG. 7, the processor(s) 702 may have a plurality of processor cores, each of which may include some or all of the components illustrated in FIGS. 1-5. For example, each processor core 704-1, 704-2, . . . , 704-N may include an instance of logic 122 for performing data control using last accessor information with respect to a shared cache 708, such as a shared cache 708-1, 708-2, . . . , 708-M for each respective processor 702-1, 702-2, . . . , 702-M. As mentioned above, the logic 122 may include one or more of dedicated circuits, logic units, microcode, or the like.

The processor(s) 702 and processor core(s) 704 can be operated to fetch and execute computer-readable instructions stored in a memory 710 or other computer-readable media. The memory 710 may include volatile and nonvolatile memory and/or removable and non-removable media implemented in any type of technology for storage of information, such as computer-readable instructions, data structures, program modules or other data. Such memory may include, but is not limited to, RAM, ROM, EEPROM, flash memory or other memory technology. Additionally, storage 712 may be provided for storing data, code, programs, logs, and the like. The storage 712 may include solid state storage, magnetic disk storage, RAID storage systems, storage arrays, network attached storage, storage area networks, cloud storage, CD-ROM, digital versatile disks (DVD) or other optical storage, magnetic cassettes, magnetic tape, or any other medium which can be used to store desired information and which can be accessed by a computing device. Depending on the configuration of the system 700, the memory 710 and/or the storage 712 may be a type of computer readable storage media and may be a non-transitory media.

The memory 710 may store functional components that are executable by the processor(s) 702. In some implementations, these functional components comprise instructions or programs 714 that are executable by the processor(s) 702. The example functional components illustrated in FIG. 7 further include an operating system (OS) 716 to mange operation of the system 700.

The system 700 may include one or more communication devices 718 that may include one or more interfaces and hardware components for enabling communication with various other devices over a communication link, such as one or more networks 720. For example, communication devices 718 may facilitate communication through one or more of the Internet, cable networks, cellular networks, wireless networks (e.g., Wi-Fi, cellular) and wired networks. Components used for communication can depend at least in part upon the type of network and/or environment selected. Protocols and components for communicating via such networks are well known and will not be discussed herein in detail.

The system 700 may further be equipped with various input/output (I/O) devices 722. Such I/O devices 722 may include a display, various user interface controls (e.g., buttons, joystick, keyboard, touch screen, etc.), audio speakers, connection ports and so forth. An interconnect 724, which may include a system bus, point-to-point interfaces, a chipset, or other suitable connections and components, may be provided to enable communication between the processors 702, the memory 710, the storage 712, the communication devices 718, and the I/O devices 722.

In addition, this disclosure provides various example implementations, as described and as illustrated in the drawings. However, this disclosure is not limited to the implementations described and illustrated herein, but can extend to other implementations, as would be known or as would become known to those skilled in the art. Reference in the specification to “one implementation,” “this implementation,” “these implementations” or “some implementations” means that a particular feature, structure, or characteristic described is included in at least one implementation, and the appearances of these phrases in various places in the specification are not necessarily all referring to the same implementation.

### CONCLUSION

Although the subject matter has been described in language specific to structural features and/or methodological acts, it is to be understood that the subject matter defined in the appended claims is not necessarily limited to the specific features or acts described. Rather, the specific features and acts are disclosed as example forms of implementing the claims.

1. A processor comprising:
a cache having a plurality of cache lines to store data;
a plurality of processor cores to share the data stored in the cache;
a data structure to include a plurality of entries, each entry corresponding to one of the cache lines in the cache; and
an indicator associated with a respective entry in the data structure, the indicator to identify a processor core of the plurality of processor cores that last requested access to the cache line corresponding to the respective entry.

2. The processor as recited in claim 1, further comprising logic to update an entry in the data structure in response to a request for data in the cache.

3. The processor as recited in claim 2, in which the logic is to update the indicator for a particular entry in the data structure to identify a particular processor core that last requested access to the particular cache line in the cache corresponding to the particular entry.

4. The processor as recited in claim 3, in which the logic is to send a request for data to only the particular processor core that last requested access to the particular cache line.

5. The processor as recited in claim 1, further comprising a missed address file (MAF) associated with each processor core, the MAF having an entry to receive information related to a request for data corresponding to a particular cache line when the particular processor core that receives the request for data recently requested the data and has not yet received a fill of the particular cache line.

6. The processor as recited in claim 1, in which the data structure is a distributed data structure maintained at multiple processor cores of the plurality processor cores by logic implemented by multiple controllers corresponding to the multiple processor cores.

7. A method comprising:
receiving, from a particular processor core of multiple processor cores, a data access request for data corresponding to a particular cache line in a cache able to be shared by the multiple processor cores;
accessing a data structure having a plurality of entries, each entry corresponding to a cache line of a plurality of cache lines in the cache; and
updating a field in a particular entry in the data structure that corresponds to the particular cache line to identify that the particular processor core has most recently requested the data corresponding to the particular cache line.

8. The method as recited in claim 7, in which the particular processor core is a first processor core, the method further comprising sending a request for the data to a second processor core that has the data in a local cache.

9. The method as recited in claim 8, further comprising:
receiving, from a third processor core, a second request for the data corresponding to the particular cache line; and
updating the field in the particular entry in the data structure that corresponds to the particular cache line to identify that the third processor core has most recently requested the data corresponding to the particular cache line.

10. The method as recited in claim 9, further comprising sending, to the first processor core, a request for providing the data to the third processor core.

11. The method as recited in claim 10, further comprising, when the first processor core has not yet received a fill for the particular cache line from the second processor core, updating an entry in a missed address file at the first processor core in response to the first processor core receiving the request for providing the data to the third processor core.

12. The method as recited in claim 11, further comprising:
receiving the fill for the particular cache line at the first processor core from the second processor core; and
based on the entry in the missed address file, providing from the first processor core, a subsequent fill of the particular cache line to the third processor core.

13. The method as recited in claim 8, further comprising, when the data has been evicted from the local cache at the second processor core prior to receiving the request for the data at the second processor core, filling the request for the data from a victim buffer associated with the second processor core.

14. The method as recited in claim 7, in which accessing the data structure further comprises accessing the data structure based on a memory address corresponding to the particular cache line.

15. The method as recited in claim 7, in which the field is a first field, the method further comprising updating a second field in the particular entry in the data structure to indicate which processor cores of the plurality of processor cores currently share the particular cache line.

16. A system comprising:
a plurality of processor cores;
at least one cache having a plurality of cache lines, the plurality of processor cores able to share the at least one cache; and
a controller maintaining a directory to include a plurality of entries, each entry corresponding to one of the cache lines, each entry including:
a memory address associated with data maintained in the cache line corresponding to the entry; and
a field to identify a processor core of the plurality of processor cores that most recently requested the data of the cache line corresponding to the entry.

17. The system as recited in claim 16, in which there are a plurality of the controllers and the directory is a distributed data structure, each controller to access a portion of the directory maintained at a particular processor core.

18. The system as recited in claim 16, in which the controller is to execute instructions to send a request for data corresponding to a particular cache line to only a particular processor core identified in the directory as having last accessed the particular cache line.

19. The system as recited in claim 16, further comprising a missed address file (MAF) associated with each processor core, the MAF having an entry to receive information related to a request for data corresponding to a particular cache line when a particular processor core that receives the request for data recently requested the data and has not yet received a fill of the particular cache line.

20. The system as recited in claim 16, each entry further comprising a vector associated with each memory address, the vector to indicate one or more processor cores of the plurality of processor cores that have a copy of the data stored on a local cache.
